(19) United States
(12) Patent Application Publication
(10) Pub. No.: US 2004/0142160 A1
(43) Pub. Date: Jul. 22, 2004

(54) Wood fiber polymer composite extrusion and method

(75) Inventors: Chuck Cannon, Issaquah, WA (US); George Melkonian, Federal Way, WA (US); John Hammock, Federal Way, WA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Mikron Industries, Inc., Kent, WA

(21) Appl. No.: 10/718,970

(22) Filed: Nov. 21, 2003

Related U.S. Application Data
(63) Continuation of application No. 09/452,906, filed on Mar. 6, 2000, now abandoned.

(51) Int. Cl. B32B 3/26; B32B 5/22; B32B 9/00; B32B 5/20

(52) U.S. Cl. 428/304.4; 428/318.4; 428/317.9; 428/318.8

(57) ABSTRACT

A method for extruding a thermoplastic polymer/wood fiber composite utilizes styrene acrylonitrile as the principal thermoplastic component. Acrylonitrile butadiene styrene is used as a stiffener and modifier to prevent degradation of a foaming agent's efficacy. The method of the invention and the extrusion produced by the inventive method are particularly applicable to extrusions having high aspect ratio cross-sectional shapes and extrusions in which the ratio of wall thickness to interior volume is large.

### TECHNICAL FIELD

The invention relates to a composite polymer/wood fiber extrusion and a method for making the same. More specifically, the invention relates to a foamed cellulosic/polymer extrusion and a method for making the same.

### BACKGROUND OF THE INVENTION

Composite wood fiber/polymer extrusions have been available for a number of years. The art with respect to the manufacture of such extrusions, particularly combining wood fibers having a mesh size between approximately 40 mesh and 80 mesh, and thermoplastic polymers, primarily polyolefins is well developed. An early application for such a composite related to the extrusion of a mixture comprising 50% by weight wood fiber and 50% by weight polypropylene for use in car door panels and other interior automotive parts. This process had significant economic advantages, particularly in the early 70's when wood fiber was essentially a low or no lost waste product from wood processing facilities and the price of petroleum was relatively unstable. Extruders could vary the percentage of waste wood, cellulosic material in the extrusion depending on the price of polypropylene feed stock which was, of course, dependent upon the price of oil. Other extruders recognized not only the economic merit of such a product but also recognized that a variety of wood only products, such as decking, pallets, and containers could be replaced with wood/thermoplastic extrusions because the price of virgin wood was climbing rapidly. Extruders eventually acquired the ability to co-extrude waste wood products with polyvinyl chloride thermoplastics as well as polypropylenes and polyethylenes.

Problems relating to co-extrusion of wood fibers and a thermoplastic polymer component are well explained in U.S. Pat. No. 5,851,469 to Muller et al. issued Dec. 22, 1998, the disclosure of which is incorporated herein by reference. Muller et al. described the typical prior art steps for co-extruding a thermoplastic polymer with wood fiber. In a first step, the wood fiber is dried using conventional techniques to a moisture content of less than 8% by weight. In a second step the wood fiber and plastic material are preheated to a temperature of approximately 176° F. to 320° F. In a third step, the materials are mixed or kneaded at a temperature of 248° F. to 482° F. to form a paste. In a fourth and final step, the paste is either injection molded or extruded into a final form. If the paste is extruded, the extrudate must be calibrated and cooled. The Muller et al. reference specifically addresses the problem of controlling the temperature of the extrudate through various stages of the extrusion process to prevent undesirable sheer stresses from arising during the extrusion process. Muller et al. also teach that a particular problem involved with wood fiber/thermoplastic composite extrudates involves volatiles in the wood component boiling off at extrusion temperatures causing an undesirable foaming of the extrudate.

U.S. Pat. No. 5,746,958 to Gustafson et al. further explains that particularly when using post-consumer polymers (usually polyethylenes) the vagaries of the characteristics of this component, when combined with the problem of wood volatile boil off creates difficulties in producing a uniform composite extrudate. Specifically, Gustafson et al. teach that a high volume extruder must be fed a minimum volume of a continuous product (e.g. feed stock) stream. To satisfy this demand within the parameters of the problem discussed above, Gustafson et al. teach a method of pelletizing the thermoplastic component so as to produce a uniform feed stock having known characteristics. Two or more different thermoplastic, pelletized feed stocks are provided and then blended with wood fibers to produce an extrudate having consistent quality characteristics. The disclosure of the '958 patent is incorporated herein by reference.

U.S. Pat. No. 5,425,954 to Wold describes methods for molding wood fiber/thermo-setting resins to produce oriented strand board type products and is thus illustrative of the differences between continuously extruding thermoplastic wood fiber/thermoplastic extrusions and hot press molding of wood fiber/thermo-setting composite products. U.S. Pat. No. 5,759,680 to Brooks is believed to disclose the current state of the art for preparing a wood fiber/thermoplastic extrusion suitable for use in the building trades.

U.S. Pat. No. 5,486,553 to Deaner et al. discloses a polymer/wood thermoplastic composite structural member, suitable for use as a replacement for a wood structural member, such as for window components. The preferred thermoplastic component is polyvinyl chloride (PVC) and sawdust. In a preferred embodiment of the invention, a double hung window unit is disclosed having cell, jamb and header portions comprising hollow, multi-compartment lineal extrusions which can be made from the disclosed thermoplastic polymer/wood fiber composite. The resulting extrusion has mechanical properties which are similar to wood, but have superior dimensional stability, and resistance to rot and insect damage as compared to conventional wood products.

In addition to the above prior art, it is known that foamed PVC/wood fiber composite extrusions have been prepared. A foamed extrusion substantially reduces the amount of polymer necessary per unit volume of extrusion because the foaming process produces a plurality of interstitial voids within an otherwise solid extrudate in cross-section. One disadvantage of this type of extrusion is that the flexural modulus for this type of a foamed PVC product is relatively low (e.g. 170,000) whereas the flexural modulus for ponderosa pine is typically 900,000.

Hollow, extruded profiles can be manufactured with webs and other internal structural members to produce virtually any desired macroscopic mechanical property. However, in extrusions having an extremely high aspect ratio in cross-section (e.g. slats for Venetian style blinds) it is mechanically impossible to provide the extrudate with a wall thickness sufficient to provide the desired macroscopic mechanical characteristics, particularly bending moment. In this area of product application, a product having a solid cross-section from a foamed material is preferred. Unfortunately, prior attempts to introduce wood fiber into a foamed polymer extrudate demonstrates that the wood fiber tends to counteract the effect of the foaming agent. As a result, such prior art foamed PVC/wood fiber extrusions have limited the wood fiber content to 5% by weight or less. Such a small wood fiber component does little to reduce the petroleum product content or to improve the mechanical properties of the extrudate.

Nevertheless, a need exists for a composite extrusion having a thermoplastic component and a wood fiber component which uses substantially less thermoplastic component per unit weight of finished extrusion as compared to the products made by the processes described above in the prior art. In addition, a need exists for a thermoplastic polymer/wood fiber composite extrusion which is sufficiently rigid to supplant standard solid wood components in a variety of installations such as Venetian style window shades and blinds.

### SUMMARY OF THE INVENTION

It is therefore an object of the present invention to provide a foamed, continuous thermoplastic/cellulose fiber composite lineal extrusion employing a styrene acrylonitrile (hereinafter “SAN”) component, a cellulosic material component and acrylonitrile butadiene styrene (hereinafter ABS) resin and a foaming agent.

In a preferred embodiment of the invention, the extrudate is prepared from a feed stock material comprising approximately 70% to 90% by weight SAN, approximately 5% to 25% by weight cellulosic material, approximately 2% to 27% by weight ABS resin and a trace amount of lubricant and foaming agent. The SAN feed stock component is preferably pelletized with the cellulosic material and is introduced into a conventional multi-screw extruder and various ratios of medium molecular weight, high molecular weight, and ultra-high molecular weight SAN with the ABS resin. The foaming agent is preferably injected down stream from a mixing a unit for the above components and upstream of a forming die connected to the extruder. The extrusion is then preferably calibrated to the desired size and shape.

An extrudate prepared by the inventive method preferably has a heat deflection temperature rating of not less than 170° F., a flexural modulus of at least 307,000 psi, a coefficient of thermal expansion of not more than approximately 3.33×10⁻⁵ inches per inch per degree Fahrenheit, and a thermal conductivity rating of not more than approximately 0.6 BTU inch per hour ft² square degree Fahrenheit. The preferred cellulosic material is wood fiber having a mesh size in the range of 40 mesh to 200 mesh, and in the preferred embodiment having a size of approximately 60 mesh.

The invention has particular utility with respect to extrusion profiles having a relatively high aspect ratio in cross-section, such as slats for Venetian style blinds.

### BRIEF DESCRIPTION OF THE DRAWINGS

FIG. 1 is an environmental, isometric view of a high speed polymer extrusion apparatus for use with the method of the present invention.

FIG. 2 is a schematic representation in block diagram form of the process of the present invention.

FIG. 3 is an enlarged, cross-sectional view of an extrudate manufactured by the method of the present invention.

FIG. 4 is an alternate embodiment of the extrudate.

### DETAILED DESCRIPTION OF THE PREFERRED EMBODIMENTS

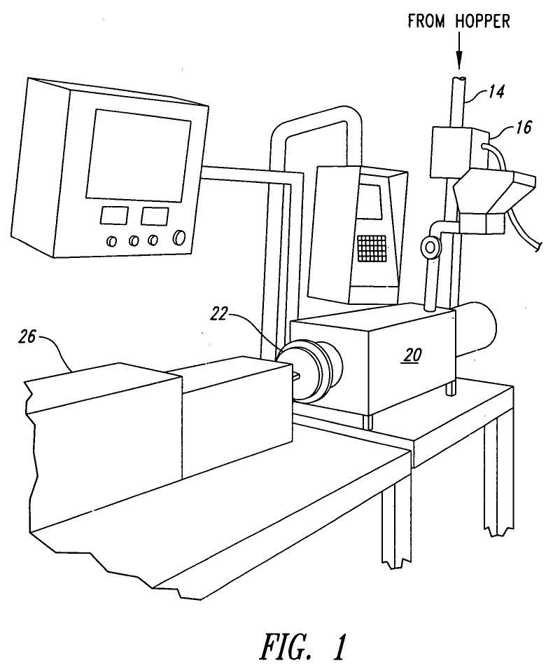

A conventional, twin screw extruder for use with the method of the present invention is generally indicated at reference numeral 10 in FIG. 1. The extruder 10 includes a hopper or mixer 12, for accepting a feed stock consisting of a thermoplastic polymer/wood composite pelletized material, a conduit 14 for connecting the hopper with a preheater 16 for controlling the temperature of an admixture of the feed stock in the hopper 12, and an inlet 18 for introducing a foaming agent. The preheater 16 is connected to a multi-screw chamber 20 for admixing the feed stock with the foaming agent and other conditioners to be described herein below under controlled conditions of temperature and pressure. Chamber 20 is connected to an extrusion die 22 which produces an extrudate 24. The extrudate is preferably calibrated in a conventional calibrator 26 to result in a final product shown in FIGS. 3 and 4. An appropriate extruding machine 10 is available from Cincinnati Millacron Corporation, Cincinnati, Ohio, USA.

The extruder 10 and calibrator 26 are conventional apparatus, the operation of which is well understood by those of ordinary skill in the thermoplastic polymer extrusion art. The extrudate 24 shown in FIG. 3 is a foamed, continuous thermoplastic/cellulose fiber composite lineal extrusion adapted for use as a slat or louver in a window blind construction, commonly referred to as a Venetian blind. The extrusion has excellent strength to weight characteristics, and has a workability and surface finish similar to a milled wood product from a coniferous tree, such as ponderosa pine. The extrusion has a heat deflection temperature rating of not less than 170° F., a flexural modulus of approximately 307,000 psi, a coefficient of thermal expansion of not more than 3.33×10⁻⁵ inch per inch per degree F., and a thermal conductivity rating of not more than approximately 0.6 BTU's per hour per °F². The extrusion preferably also has a density of not more than approximately 0.6 grams per cm³.

The extrusion produced by the method of the invention has particular utility with respect to an extrudate, such as that shown in FIG. 3, having a high aspect ratio in cross-section. Such high aspect ratio extrusions are often difficult to form as a conventional hollow extrusion having the desired macroscopic physical properties of bending moment, workability, screw retention, etc., in a cost effective manner. Stated another way, it is difficult to produce a very narrow, hollow extrusion having a high bending moment, and good screw retention without employing a complex web structure within the extrusion and pre-drilled screw holes. While such structures are technically possible to incorporate in a hollow extrusion, these features increase the raw material cost, wall thickness, and engineering complexity of the die used to produce the extrusion. A foamed extrusion can be produced which uses significantly less polymer component per unit length of extrusion than a high aspect ratio engineered hollow extrusion having similar macroscopic physical characteristics.

The assignee of the present invention has discovered that it is possible to produce a foamed thermoplastic extrusion having wood fiber as a significant component thereof. Prior attempts to produce a foamed extrusion having wood fiber as a significant component have been unsuccessful, as the wood fiber tends to degrade the effectiveness of conventional foaming agents. In particular, polyolefins such as polyethylene and polypropylene do not adhere well to wood and significant modifiers are needed (usually a thermo-setting resin, 2% to 3% by weight). Polyvinyl chloride (PVC) bonds well to wood fibers because like wood fibers it is a polar molecule. Unfortunately, prior attempts to foam a PVC/wood fiber composite extrusion have only been successful wherein the wood fiber component is 5% by weight or less. In such low ratios, the wood fiber has little structural effect on the resulting extrusion and does not achieve any of the significant advantages of a wood fiber/thermo-setting polymer extrusion, including rot resistance, paintability, stainability and workability characteristics similar to a milled wood product such as pine. It is an aspect of the present invention that, contrary to conventional wisdom, a foamed thermo-plastic polymer/wood composite extrusion can be produced having a high proportion of cellulosic material content in the form of wood fiber in the range of 5% to 25% by weight wherein the principal thermoplastic polymer ingredient is styrene acrylonitrile (SAN) in the range of 70% to 90% by weight. Table I illustrates one preferred formulation used for the production of a foamed, thermoplastic/cellulosic material composite extrudate suitable for use as a slat in a window blind, of the type shown in FIG. 3.

TABLE I

| | PERCENT RANGE |
|---|---|
| INGREDIENT | (by weight) |
| SAN | 70-90 |
| Wood Fiber | 5-25 |
| ABS | 2-8 |
| Lubricant | 0.1-0.5 |
| Foaming Agent | 0.5-3 |

An appropriate SAN product is available from General Electric Specialty Chemicals, Morgantown, W. Va., as well as from Kumho, South Korea. Specifically, the General Electric products Blendex 570, 576, and 869, as well as Kumho SAN 350 have proven satisfactory for this purpose. A suitable ABS component used as a modifier is General Electric's Blendex 360 product. A suitable foaming agent is available from Color Matrix of Cleveland, Ohio, under the designation 80-428-1. Magnesium stearate has been found to be a suitable lubricant. It is believed that ethylene-bis-stearimide and calcium stearate in the same proportions as given above are also suitable lubricants.

Substantial success has also been achieved by alloying different molecular weight SAN products. Another alternate formation is shown in Table II below.

TABLE II

| | PERCENT RANGE |
|---|---|
| INGREDIENT | (by weight) |
| High Molecular Weight SAN | 0-85 |
| Medium Molecular Weight SAN | 5-90 |
| Ultra-High Molecular Weight SAN | 1-5 |
| Wood Fiber | 5-25 |
| ABS | 2-8 |
| Lubricant | 0.1-0.5 |
| Foaming Agent | 0.5-3 |

It is preferred that the SAN/wood fiber component be prepared as a pelletized feed stock for admixture with the ABS modifier, lubricant and foaming agent. An appropriate pelletized product is available from Northwoods Company, Sheboygan, Wis. A typical wood fiber mesh size for this pelletized product is 60, but an acceptable range may be from 40 mesh to 200 mesh. The pelletized compound consists of 20% to 80% by weight medium molecular weight (MMW) SAN, 20% to 80% wood fiber, and 0.4% to 2.0% lubricant. A resulting general formula for extrusion is shown in Table III below.

TABLE III

| | PERCENT RANGE |
|---|---|
| INGREDIENT | (by weight) |
| Northwoods Pellets | 6-90 |
| MMW SAN | 0-85 |
| HMW SAN | 0-85 |
| UHMW SAN | 1-5 |
| ABS | 2-8 |
| Foaming Agent | 0.5-3 |

A particular preferred embodiment of the invention is shown in Table IV below.

TABLE IV

| INGREDIENT | PERCENT |
|---|---|
| Northwoods Pellet | 26 |
| Kumho SAN 350 | 65 |
| GE B-869 UHMW SAN (Stiffener) | 2 |
| GE B-360 ABS (Modifier) | 5.2 |
| Color Matrix Foaming Agent 80-428-1 | 0.8 |

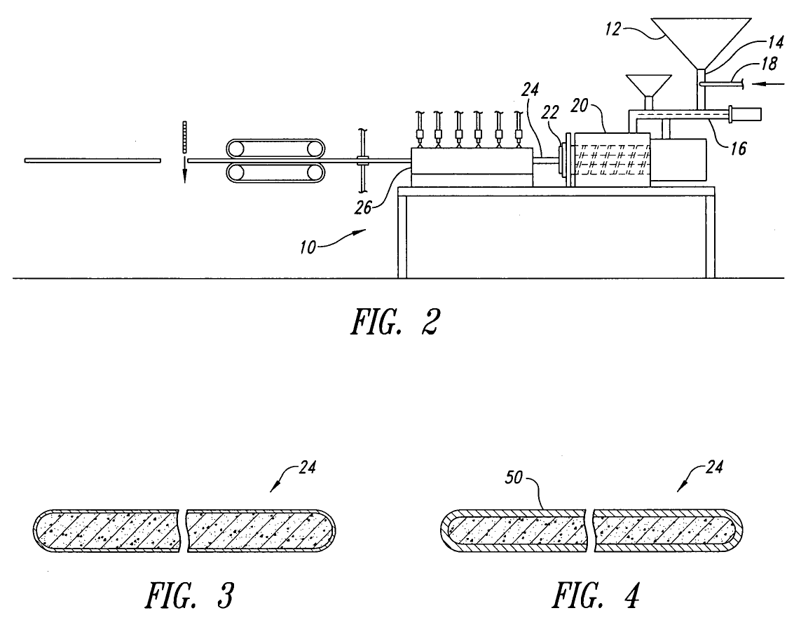

In FIG. 2, the SAN/wood fiber pelletized feed stock is added into the hopper or mixing unit 12, along with the additional Ultra High Molecular Weight (UHMW) SAN stiffening agent, ABS resin modifier and either Medium Molecular Weight (MMW) SAN or High Molecular Weight (HMW) SAN. The ratios of UHMW to MMW or HMW SAN can be varied in accordance with the skill level of the artisan to provide an extrusion having varying macroscopic physical properties. Once mixed, the resulting compound is gravity fed through the conduit 14 to the extruding chamber 20. The foaming agent is added on line by way of inlet 18 through a peristaltic pump Model CM100 manufactured by Color Matrix of Cleveland, Ohio. The pump speed can range from 7 rpm to 12 rpm according to the feed rate of the feed stock and speed of the mixer. The extrudate 24 appears at the exit of the extrusion die 22 in the desired form. An appropriate extruder 10 is a Model CM 55 manufactured by Cincinnati Millacron, Batavia, Ohio.

The extrudate 24 shown in FIG. 3 can be used as wood product replacement in a wide variety of applications. One application utilized by the assignee of the present invention is as a slat for a window blind. Those of ordinary skill in the art will appreciate other applications suitable for the extrudate of the present invention when extruded in a variety of cross-sectional shapes. The extrudate has physical characteristics remarkably similar to ponderosa pine and superior to rigid PVC and foamed PVC products. Table V illustrates results of tests conducted by the assignee of the present invention comparing various physical properties of the inventive extrudate manufactured by the method of the present invention compared to rigid PVC and two competitive foamed PVC products.

TABLE V

| | | 1ST | 2ND | | | |
|---|---|---|---|---|---|---|
| | | FOAMED | FOAMED | | INVENTIVE | |
| | RIGID | PVC | PVC | INVENTIVE | EXTRUDATE | PONDEROSA |
| | PVC | PRODUCT | PRODUCT | EXTRUDATE | w/PVC Cap | PINE |
| Heat | 145° F. | 151° F. | 153° F. | 175° F. | 165° F. | N/A |
| Deflection | | | (165° F.) | | | |
| Temperature | | | | | | |
| ASTM D648 | | | | | | |
| Vicat | 190° F. | 173° F. | 179° F. | 217° F. | 219° F. | N/A |
| Softening | | | | | | |
| Point | | | | | | |
| ASTM D1525 | | | | | | |
| Flexural | 390,000 | 128,000 | 257,000 | 307,000 | 220,000 | 1,290,000 |
| Modulus | psi | psi | psi | psi | psi | psi |
| ASTM D790 | | | | | | |
| Direct | 456 lbf | 242 lbf | 291 lbf | 527 lbf | 319 lbf | 163 lbf |
| Screw | | | | | | (ASTM |
| Withdrawal | | | | | | D1761) |
| ASTM D1037 | | | | | | |
| Hardness, | 82 | 83 | 62 | 79 | 56 | |
| Type | | | | | | |
| ‘D’ | | | | | | |
| Durometer | | | | | | |
| Coefficient | 3.59 × 10⁻⁵ | (1.8 × 10⁻⁵ | | 3.33 × 10⁻⁵ | 3.19 × 10⁻⁵ | 2.5 × 10⁻⁶ |
| of Thermal | in/in/° F. | in/in/° F.) | | in/in/° F. | in/in/° F. | in/in/° F. |
| Expansion | | | | | | |
| Thermal | 0.69 | | 0.46 | 0.45 | | 1.6-2.9 |
| Conductivity | btu-inch | | btu-inch | btu-inch | | |
| ASTM D177 | \overline{ft²-hr-° F.} | | \overline{ft²-hr-° F.} | \overline{ft²-hr-° F.} | | |
| Water | 0.09% | 0.45% | | 0.56% | 5.16% | 17.2% |
| Absorption | | | | | | |
| ASTM D1037 | | | | | | |
| Density | 1.45 | 0.69 | 0.63 | 0.51 | | |
| | g/cc | g/cc | g/cc | g/cc | | |

FIG. 4 illustrates an alternate embodiment of the invention in which the extrudate 24 is co-extruded with a polyvinyl chloride cap stock 50. The cap stock is co-extruded in a manner well known to those of ordinary skill in the thermoplastic extrusion art.

Those of ordinary skill in the art will, upon reviewing the above disclosure conceive of other embodiments and variations of the invention. Therefore, the invention is not to be limited by the above description, but is to be determined in scope by the claims which follow.

We claim:

1. A foamed, continuous thermoplastic/cellulose fiber composite lineal extrusion made from an admixture, comprising:
approximately 70% to 90% by weight styrene acrylonitrile (SAN) component;
approximately 5% to 25% by weight cellulosic material;
approximately 2% to 27% by weight acrylonitrile butadiene styrene (ABS) resin;
approximately 0.1% to 0.4% by weight lubricant; and,
approximately 0.4% to 3% by weight foaming agent.

2. The extrusion of claim 1, wherein the styrene acrylonitrate component is an alloy of approximately 5% to 90% by weight medium molecular weight SAN, approximately 0% to 85% by weight high molecular weight SAN, and approximately 1% to 5% by weight ultra high molecular weight SAN.

3. The extrusion of claim 1, wherein the cellulosic material is wood fiber having a mesh size in the range of approximately 40 mesh to 200 mesh.

4. The extrusion of claim 3, wherein the wood fiber has a mesh size of approximately 60 mesh.

5. The extrusion of claim 1, wherein the lubricant is magnesium stearate.

6. The extrusion of claim 1, wherein the extrusion has the following characteristics:
a heat deflection temperature rating of not less than approximately 170 degrees F.;
a flexural modulus of 307,000 pounds per square inch;
a coefficient of thermal expansion of not more than approximately 0.0000333 inches per inch per degree F.; and,
a thermal conductivity rating of not more than approximately 0.6 British Thermal Unit inch per ft² hour degree F.

7. The extrusion of claim 6, wherein the extrusion has a density of not more than approximately 0.60 grams per cubic centimeter.

8. The extrusion of claim 1, wherein the extrusion has a substantially high aspect ratio in cross sectional shape and a coextruded polyvinyl chloride (PVC) cap.

9. A method for making a foamed, continuous thermoplastic/cellulose fiber composite lineal extrusion, comprising the steps of:
preparing a pelletized feed stock having approximately 70% to 90% by weight styrene acrylonitrate (SAN) component, approximately 5% to 25% by weight cellulosic material, and approximately 0.1% to 2.0% by weight lubricant;
introducing approximately 6% to 90% by weight of the pelletized feed stock into a mixing unit connected to a conventional multi-screw extruder;
simultaneously adding to the mixing unit an approximately 0% to 85% by weight medium molecular weight (MMW) SAN component, a 0% to 85% by weight high molecular weight (HMW) SAN component, a 1% to 5% by weight ultra-high molecular weight (UHMW) SAN component, and a 2% to 27% by weight ABS resin component;
injecting a 0.4% to 3% by weight foaming agent into the extruder downstream from the mixing unit and upstream of a forming die connected to the extruder to form an extrudate; and,
calibrating the extrudate.

10. The method of claim 9, wherein the pelletized feed stock SAN component is approximately 20% to 80% by weight MMW SAN, and wherein the cellulosic material is wood fiber having a mesh size in the range of 40 mesh to 200 mesh.

11. The method of claim 9, wherein the lubricant is magnesium stearate.

12. The method of claim 9, wherein the extrudate has the following characteristics:
a heat deflection temperature rating of not less than approximately 170 degrees F.;
a flexural modulus of 307,000 pounds per square inch;
a coefficient of thermal expansion of not more than approximately 0.0000333 inches per inch per degree F.; and,
a thermal conductivity rating of not more than approximately 0.6 British Thermal Unit inch per ft² hour degree F.

13. A foamed, continuous thermoplastic/cellulose fiber composite lineal extrusion product, made by the following process:
preparing a pelletized feed stock having an approximately 70% to 90% by weight styrene acrylonitrate (SAN) component, approximately 5% to 25% by weight cellulosic material, and approximately 0.1% to 2.0% by weight lubricant;
introducing approximately 6% to 90% by weight of the pelletized feed stock into a mixing unit connected to a conventional multi-screw extruder;
simultaneously adding an approximately 0% to 85% by weight medium molecular weight (MMW)SAN component, a 0% to 85% by weight high molecular weight (HMW) SAN component, a 1% to 5% by weight ultra-high molecular weight (UHMW) SAN component, and a 2% to 27% by weight acrylonitrile butadiene styrene (ABS) resin component to the mixing unit; and,
injecting a 0.4% to 3% by weight foaming agent into the extruder downstream from the mixing unit and upstream of a forming die connected to the extruder.

14. The method of claim 13, wherein the pelletized feed stock SAN component is approximately 20% to 80% by weight MMW SAN, and wherein the cellulosic material is wood fiber having a mesh size in the range of 40 mesh to 200 mesh.

15. The method of claim 13, wherein the lubricant is magnesium stearate.

16. The method of claim 13 wherein the extrusion has a substantially high aspect ratio in cross sectional shape and is coextruded with a polymer cap.
